(19) United States
(12) Patent Application Publication
(10) Pub. No.: US 2026/0024750 A1
(43) Pub. Date: Jan. 22, 2026

(54) SILICON ANODES HAVING ENHANCED ELECTRONIC CONDUCTIVITY AND SPECIFIC CAPACITY

(71) Applicants: Leon L. SHAW, Chicago, IL (US); Bingyu LIU, Chicago, IL (US)

(72) Inventors: Leon L. SHAW, Chicago, IL (US); Bingyu LIU, Chicago, IL (US)

(73) Assignee: ILLINOIS INSTITUTE OF TECHNOLOGY, Chicago, IL (US)

(21) Appl. No.: 18/775,780

(22) Filed: Jul. 17, 2024

(51) Int. Cl. H01M 4/1395; H01M 4/02; H01M 4/04; H01M 4/133; H01M 4/134; H01M 10/0563

(52) U.S. Cl. CPC H01M 4/1395; H01M 4/045; H01M 4/133; H01M 4/134; H01M 10/0563; H01M 2004/028

(57) ABSTRACT

A metal-coated silicon anode, and a method of improving silicon based anodes. A silicone anode, such as including a plurality of silicon and/or silicon oxide particles, is placed in an electrochemical cell having an opposing cathode, an electrolyte, and a power source connected to the silicon anode and the cathode. A metallic salt is added to the electrolyte to form metal ions. Upon delivering an electric current to the anode, a layer of metal is electrochemically deposited on surface of the silicon particles in the anode. The metal ions are reduced to a metal layer on the surface of the silicon particles in the anode. The metal coating enhances electronic conductivity and/or specific capacity of the Si-based anode.

### STATEMENT REGARDING FEDERALLY SPONSORED RESEARCH OR DEVELOPMENT

This invention was made with government support under grant IIP-1918991 awarded by the National Science Foundation. The government has certain rights in the invention.

### FIELD OF THE INVENTION

This invention relates generally to lithium ion batteries and, more particularly, to silicon anodes for such batteries. This invention more specifically relates to fabricating high performance Si-based anodes for lithium ion batteries and, more particularly, to improved anodes and a method of enhancing electronic conductivity and/or specific capacity of Si-based anodes via in-situ electrochemical deposition of metallic coating.

### BACKGROUND OF THE INVENTION

Lithium ion (Li-ion) batteries have revolutionized portable electronic devices in the past two decades, and have the potential to make great future impacts in a variety of areas including vehicle electrification. Batteries with high energy density, high power density and long cycle life are in urgent demand to address the problems, issues and challenges faced by Li-ion batteries in providing desired driving range or distance and providing desirably rapid charging or recharging.

In this context, silicon is one of the most promising anode candidates for next-generation Li-ion batteries. This is largely due to silicon's low voltage profile and high theoretical capacity (3590 mA h g⁻¹ for Li₁₅Si₄ phase at room temperature), which is about ten times that of carbonaceous materials including graphite, pyrolytic carbon and meso-phase pitch (about 372 mA h g⁻¹).

Si-based anodes generally have three major challenges that have prevented them from being employed in Li-ion batteries for a wide range of practical applications. First, they all have enormous volume change, e.g., ˜300% volume change for Si anodes, during de/lithiation processes. Second, they have low intrinsic electronic conductivity. Third, the solid electrolyte interphase (SEI) on their particle surface often repeatedly fractures and re-forms owing to the large volume change during de/lithiation processes. Numerous methods have been devised to address these challenges, including (i) reduction of Si-based materials to nanoscales to minimize volume change per particle, (ii) applying conductive coating and/or blending with conductive materials to solve the low electronic conductivity problem, (iii) introduction of engineered voids to accommodate the large volume change and provide a mechanically stable interface to avoid repeated fracture and re-formation of SEI layers, (iv) use of strong binders to prevent Si-based materials from loss contact with the conductive carbon black (CB) network, and (v) design of electrolyte compositions for the formation of a durable and less reactive SEI layer. There is a continuing need for improved Si-based battery components.

### SUMMARY OF THE INVENTION

A general object of the invention is to provide an enhanced silicon based anode for lithium ion batteries. This invention focuses on electrochemically depositing a thin layer of metal, such as Sn, In, Mg, Al or Ca metal coating on the surface of the Si-based particles in the anode in-situ, such as during the first battery charge operation(s).

The invention includes a method of improving silicon based anodes by electrochemically depositing a layer of a metal on silicon surfaces of the anode. In embodiments, the silicon based anode includes a plurality of silicon and/or silicon oxide particles, having surfaces coated with the layer of metal. The base anode can be formed by binding a plurality of silicon particles together and/or to a current collector. The silicon based anode can further include, for example, carbon particles, carbon nanotubes, carbon coatings, graphene and/or other known anode components.

In embodiments, the metal coating includes tin (Sn), indium (In), magnesium (Mg), aluminum (Al), calcium (Ca), or combinations thereof. The metal coatings are desirably applied in and during operation of an electrochemical cell including the anode. A corresponding metallic salt is added to the cell's electrolyte to provide metal ions for the coating.

Embodiments of the invention includes steps of providing an electrochemical cell including the electrolyte, the silicon anode, and an opposing cathode, and applying an electric current to the anode to attract ions of the metal to coat silicon particles in the anode.

Exemplary metallic salts include, without limitation, a metal-trifluoromethanesulfonylimide, metal tetrafluoroborate, metal hexafluorophosphate, metal bis(oxalato)borate, metal difluoro(oxalato)borate, or combinations thereof. Presently preferred salts include tin bis(trifluoromethanesulfonyl)imide (Sn(TFSI)₂), tin tetrafluoroborate (Sn(BF₄)₂), tin hexafluorophosphate (Sn(PF₆)₂), tin bis(oxalato)borate (Sn(B(C₂O₄)₂)₂), tin difluoro(oxalato)borate (Sn(BF₂C₂O₄)₂), indium bis(trifluoromethanesulfonyl)imide (In(TFSI)₃), indium tetrafluoroborate (In(BF₄)₃), indium hexafluorophosphate (In(PF₆)₃), indium bis(oxalato)borate (In(B(C₂O₄)₂)₃), indium difluoro(oxalato)borate (In(BF₂C₂O₄)₃), magnesium bis(trifluoromethanesulfonyl)imide (Mg(TFSI)₂), magnesium tetrafluoroborate (Mg(BF₄)₂), magnesium hexafluorophosphate (Mg(PF₆)₂), magnesium bis(oxalato)borate (Mg(B(C₂O₄)₂)₂), magnesium difluoro(oxalato)borate (Mg(BF₂C₂O₄)₂), aluminum bis(trifluoromethanesulfonyl)imide (Al(TFSI)₃), aluminum tetrafluoroborate (Al(BF₄)₃), aluminum hexafluorophosphate (Al(PF₆)₃), aluminum bis(oxalato)borate (Al(B(C₂O₄)₂)₃), aluminum difluoro(oxalato)borate (Al(BF₂C₂O₄)₃), calcium bis(trifluoromethanesulfonyl)imide, (Ca(TFSI)₂), calcium tetrafluoroborate (Ca(BF₄)₂), calcium hexafluorophosphate (Ca(PF₆)₂), calcium bis(oxalato)borate (Ca(B(C₂O₄)₂)₂), calcium difluoro(oxalato)borate (Ca(BF₂C₂O₄)₂), or combinations thereof.

The invention further includes a method of improving silicon based anodes, including steps of: placing a silicone anode in an electrochemical cell having an opposing cathode, an electrolyte, and a power source connected to the silicon anode and the cathode; adding a metallic salt to the electrolyte to form metal ions; and delivering an electric current to the anode to electrochemically deposit a layer of the metal ions on the surface of the silicon particles in the anode, wherein the metal ions are reduced to a metal layer on the surface of the silicon particles in the anode.

The invention also includes an anode with an anode body including a plurality of silicon or silicon oxide particles, and an electrochemically deposited layer of a metal on surfaces of the silicon or silicon oxide particles in the anode. Again, preferable metals include tin (Sn), indium (In), magnesium (Mg), aluminum (Al), calcium (Ca), or combinations thereof.

The invention further includes an electrochemical cell including the silicon-based anode of the invention. The electrochemical cell desirably begins with an uncoated anode. A metallic salt is added to the electrolyte and when electrical potential is applied to the cell, the metal ions from the metallic salt are attracted to and coat the anode silicon particles. The in-situ coating can be done before use or can occur during initial cell use.

Other objects and advantages will be apparent to those skilled in the art from the following detailed description taken in conjunction with the appended claims and drawings.

### BRIEF DESCRIPTION OF THE DRAWINGS

FIG. 1 is a schematic of in-situ electrochemical coating of a nanometer thick Sn layer on the surface of Si-based particles, in accordance with an embodiment of the present disclosure.

FIG. 2 is a graph showing the specific capacity of Si@void@C half cells as a function of cycle numbers with and without Sn(TFSI)₂ additive.

FIG. 3 is a graph showing the specific capacity of Si@void@C half cells with and without Sn(TFSI)₂ additive at different concentrations.

FIG. 4 is a graph showing the coulombic efficiency of the Si@void@C half cells with Sn(TFSI)₂ additive in the formation cycles.

### DETAILED DESCRIPTION OF THE INVENTION

The present invention provides new Si-based anodes and a method for forming the Si-based anodes. The invention provides an electrolyte composition that increases electronic conductivity of Si-based anodes, including, without limitation, particles of silicon (Si), silicon oxides (SiO, SiO₂, SiOₓ (x<2)), Si+carbon particle (Si+C) mixtures, Si+carbon nanotubes (Si+CNTs), Si+graphene mixtures, structured Si/C anodes (such as Si@void@C, Si@C, SiO₂@void@C, and SiO₂@C), and their derivatives for Li-ion batteries.

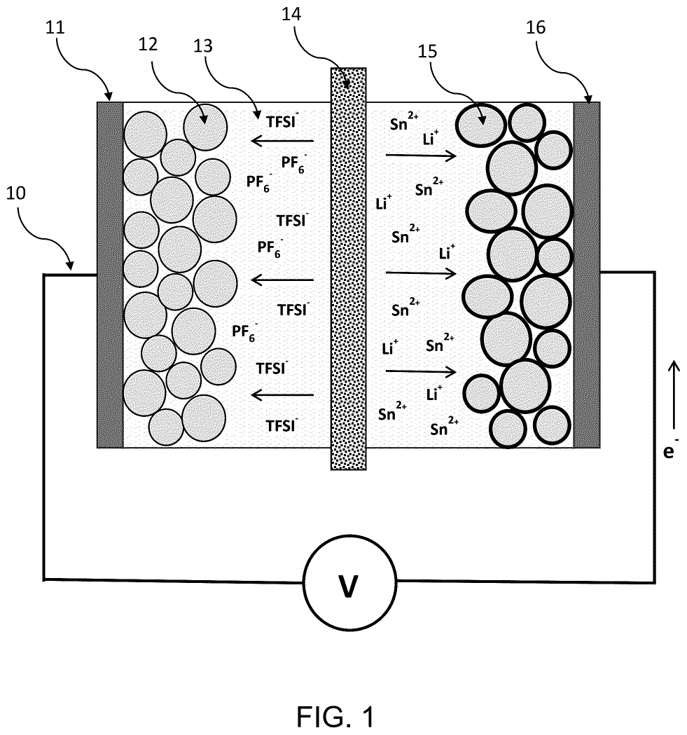

FIG. 1 shows a schematic of in-situ electrochemical coating of a nanometer thick metal (Sn) layer on the surface of Si-based anode particles, in accordance with an embodiment of the present disclosure. The electrochemical cell of FIG. 1 includes an external circuit 10 with an applied voltage for charging. The voltage source V is connected between current collector 11, such as an aluminum current collector, and current collector 16, such as a copper current collector. Cathode 12 is desirably formed of a lithium oxide, lithium iron phosphate, or other conventional cathode material, such as LiFePO₄, LiCoO₂, LiNi_{0.5}Mn_{0.5}O₂, LiNi_{0.8}Co_{0.1}Al_{0.1}O₂ and LiNi_{0.8}Mn_{0.1}Co_{0.1}O₂). Anode 15 is a silicon anode according to this invention, such as formed of silicon particles held together by any suitable binder, and the anode can optionally further include carbon particles, carbon nanotubes, carbon coatings, and/or graphene. A porous separator 14 and electrolyte 13 are disposed between the anode 15 and cathode 12.

The electrolyte is desirably a carbonate liquid electrolyte with a lithium salt (such as LiPF₆ and LiBF₄) and a metal salt additive. The metal salt additive provides metal ions that deposit on surfaces of the anode particles. In embodiments of this invention, the metal salt comprises a metal-trifluoromethanesulfonylimide (TFSI), metal tetrafluoroborate, metal hexafluorophosphate, metal bis(oxalato)borate, metal difluoro(oxalato)borate, or combinations thereof. Currently preferred metal salt additives include via the use of bis(trifluoromethanesulfonyl)imide (Sn(TFSI)₂), tin tetrafluoroborate (Sn(BF₄)₂), tin hexafluorophosphate (Sn(PF₆)₂), tin bis(oxalato)borate (Sn(B(C₂O₄)₂)₂), tin difluoro(oxalato)borate (Sn(BF₂C₂O₄)₂), indium bis(trifluoromethanesulfonyl)imide (In(TFSI)₃), indium tetrafluoroborate (In(BF₄)₃), indium hexafluorophosphate (In(PF₆)₃), indium bis(oxalato)borate (In(B(C₂O₄)₂)₃), indium difluoro(oxalato)borate (In(BF₂C₂O₄)₃), magnesium bis(trifluoromethanesulfonyl)imide (Mg(TFSI)₂), magnesium tetrafluoroborate (Mg(BF₄)₂), magnesium hexafluorophosphate (Mg(PF₆)₂), magnesium bis(oxalato)borate (Mg(B(C₂O₄)₂)₂), magnesium difluoro(oxalato)borate (Mg(BF₂C₂O₄)₂), aluminum bis(trifluoromethanesulfonyl)imide (Al(TFSI)₃), aluminum tetrafluoroborate (Al(BF₄)₃), aluminum hexafluorophosphate (Al(PF₆)₃), aluminum bis(oxalato)borate (Al(B(C₂O₄)₂)₃), aluminum difluoro(oxalato)borate (Al(BF₂C₂O₄)₃), calcium bis(trifluoromethanesulfonyl)imide, (Ca(TFSI)₂), calcium tetrafluoroborate (Ca(BF₄)₂), calcium hexafluorophosphate (Ca(PF₆)₂), calcium bis(oxalato)borate (Ca(B(C₂O₄)₂)₂), calcium difluoro(oxalato)borate (Ca(BF₂C₂O₄)₂), or combinations of these metallic salts.

The use of the metal salt additive(s) results in a nanometer thick metal surface coating on the Si particles of the anode. Presently preferred coating thickness ranges from 1 to 10 nm, while a much thicker coating >10 nm can be used as well. This coating improves the electronic conductivity of the Si-based anodes, thereby allowing more Si-based active materials to participate in the redox reactions and thus higher specific capacities and energies at given charge/discharge rates.

FIG. 1 illustrates the underlying mechanism through which in-situ electrochemical coating of a nanometer thick metallic Sn layer is deposited on the surface of Si-based particles in the anode, in accordance with an embodiment of the present disclosure. As shown in FIG. 1, the components of a Si-based battery are the same as those of a typical Li-ion battery except addition of a metal salt additive, illustrated as Sn(TFSI)₂, in the conventional carbonate electrolyte. Sn(TFSI)₂ ionizes in the carbonate electrolyte as shown in Equation 1.

$${Sn [ {( {CF}_{3} {SO}_{2} )}_{2} N ]}_{2} = {Sn}^{2 +} + 2 {( {CF}_{3} {SO}_{2} )}_{2} {N}^{-} \qquad ( 1 )$$

In the first battery charge operation, Sn²⁺ ions will migrate towards the Si-based anode driven by the external field and be reduced to Sn metal, as shown in Equation 2, depositing on the surface of the Si-based particles in the anode to improve their electronic conductivity.

$${Sn}^{2 +} + 2 {e}^{-} = Sn \qquad ( 2 )$$

The electrons for reduction of Sn²⁺ ions in Equation 2 are provided by the external field as shown in FIG. 1. The Si-based particles in FIG. 1 can be Si, SiO, SiO₂, SiOₓ (x<2), Si+carbon (C) mixture, Si+graphene mixture, Si+C nanotube, SiOₓ+C mixture, or Si/C structures (such as Si@C with a Si core and a carbon shell, Si@void@C with a Si core, a carbon shell, and engineered voids between the Si core and carbon shell, or SiO₂@C with a SiO₂ core and a carbon shell). In all of these cases the electronic conductivity of the Si-based particles will be increased immensely by a nanometer thick metallic coating. For example, the electrical conductivity of Si@void@C particles is measured to be 2.61×10⁻⁴ S/cm, which is about two orders of magnitude lower than that of carbon black (CB) powder (9.10×10⁻² S/cm). Thus, to provide sufficient electronic conductivity in the Si@void@C anode for full charge/discharge in 1 hour, a large quantity of CB powder is required, such as in a weight ratio of 60:20:20 or 80:10:10 (w/w/w) for Si@void@C powder, CB powder and polyacrylic acid (PAA) binder, respectively. However, a higher CB loading reduces the Si@void@C loading in the anode and thus effectively decreases the specific energy of a Si@void@C-based anode at the electrode level (i.e., the specific energy of the electrode computed based on the total weight of Si@void@C+CB+PAA) because CB does not contribute to the energy storage.

The aforementioned dilemma can be solved by in-situ electrochemical deposition of a nanometer thick metallic coating on the surface of Si-based particles, in accordance with an embodiment of the present disclosure. For instance, the electronic conductivities of tin (Sn), indium (In), magnesium (Mg), calcium (Ca), and aluminum (Al), are 9.1×10⁴, 1.2×10⁵, 2.3×10⁵, 2.9×10⁵, and 3.8×10⁵ S/cm, respectively, all of which are about eight orders of magnitude higher than that of Si@void@C particles (only 2.61×10⁻⁴ S/cm). Because of the greatly increased electronic conductivity, many Si@void@C particles can participate in the redox reaction even when they are not in direct contact with the conductive CB network or when fracture of Si@void@C particles occurs during charge/discharge cycles. As a result, the specific capacity of the Si@void@C anode can be boosted immensely by in-situ electrochemical deposition of a nanometer thick metallic coating.

It should be emphasized that in-situ formation is essential because it will prevent oxidation of the metallic nano-coating. Should a metallic nano-coating (such as Sn, In, Mg, Ca, and Al nano-coating) be deposited before cell assembly, these metallic nano-coatings will be oxidized in a dry room and become SnO, In₂O₃, MgO, CaO and Al₂O₃ insulators, respectively, significantly diminishing the electronic conductivity of coated Si-based particles.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

The following examples use Sn(TFSI)₂ additive to demonstrate the effectiveness of a nanometer thick metallic coating formed in-situ in the first cell charge operation and are for the illustrative purpose only. Those skilled in the art will recognize that there are numerous modifications and variations to obtain in-situ electrochemically deposited nanometer thick metallic coating on the surface of Si-based particles with superior electrochemical performance, and that the present invention is not limited to such examples.

### Example 1—Enhancing Specific Capacity Via Sn(TFSI)₂ Addition

Si@void@C particles were synthesized via a previously established method which includes: (i) high-energy ball milling of Si powder with 34 wt % polyacrylonitrile (PAN) for 12 h, (ii) carbonization of the ball milled powder at 800° C. for 5 h to form Si@C powder; and (iii) etching Si@C powder at 47° C. for 30 min to form Si@void@C powder. Si@void@C half cells in coin cell format were fabricated with polyacrylic acid (PAA) binder, and a lithium chip was used as the counter electrode. There were two types of electrolytes: (i) reference electrolyte: EC:DEC:FEC=3:6:1 v/v with 1M LiPF₆, and (ii) Sn(TFSI)₂ electrolyte: EC:DEC:FEC=3:6:1 v/v with 1M LiPF₆ and addition of 20 mM Sn(TFSI)₂ additive. The loading of Si@void@C in the electrode was 1.17 mg/cm² and the weight ratio of Si@void@C, CB and PAA binder in the Si@void@C electrode was 8:1:1.

The charging/discharging protocol of the Si@void@C half cells above consisted of two major steps. Step 1 was performed for 3 formation cycles: (1) lithiate Si@void@C at 0.05 A/g to 0.1 V vs. Li⁺/Li and hold at this potential until the current density becomes 0.005 A/g, and then delithiate the cell at 0.05 A/g to 1.0 V; (2) lithiate Si@void@C at 0.1 A/g to 0.1 V vs. Li⁺/Li and hold at this potential until the current density becomes 0.005 A/g, and then delithiate the cell at 0.1 A/g to 1.0 V; and (3) lithiate Si@void@C at 0.5 A/g to 0.1 V vs. Li⁺/Li and hold at this potential until the current density becomes 0.005 A/g, and then delithiate the cell at 0.5 A/g to 1.0 V. Step 2 was for 500 service cycles which consisted of lithiating Si@void@C at 1.0 A/g to 0.1 V vs. Li⁺/Li and holding at this potential until the current density becomes 0.05 A/g, and then delithiating the cell at 1.0 A/g to 1.0 V. This process was repeated for 500 cycles.

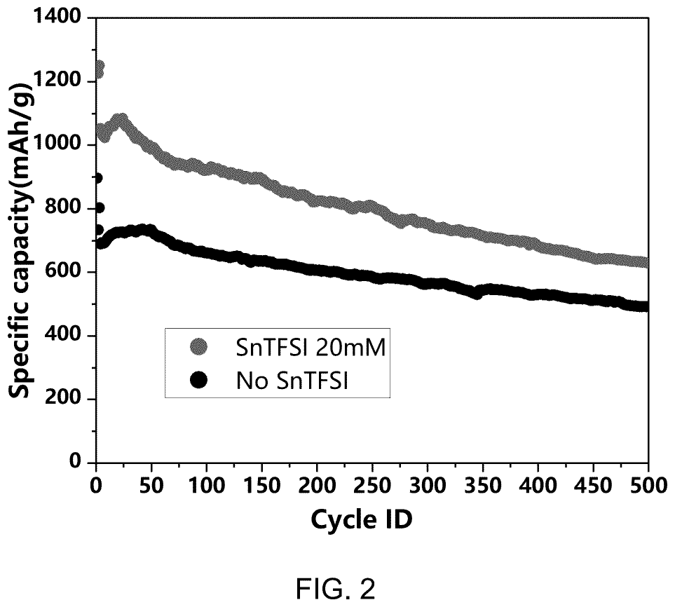

The specific capacities of the aforementioned Si@void@C half cells as a function of cycle number are shown in FIG. 2. It can be seen that the specific capacity of Si@void@C half cells at the first service cycle is improved from 693 mAh/g to 1040 mAh/g with the addition of Sn(TFSI)₂ in 20 mM concentration. This 51% improvement in the initial specific capacity is due to the improvement in the electronic conductivity which leads to participation of many more Si@void@C particles in the redox reaction during charge/discharge. Equally important, this improvement in the specific capacity continued up to 500 cycles when the experiment was terminated. A close examination of the specific capacity as a function of cycle number also reveals that the capacity decay rate for the Si@void@C electrode with Sn(TFSI)₂ addition (with only 60.38% capacity retention after 500 cycles) is faster than that for the reference electrode without Sn(TFSI)₂ (having 70.99% capacity retention after 500 cycles). This phenomenon can be attributed to the fact that participation of more Si@void@C particles in the redox reaction in the early stage of charge/discharge results in more particle degradation (due to cracking of Si@void@C particles) in the early stage and thus lower capacity retention after 500 cycles. In spite of faster capacity decay, the specific capacity of the Si@void@C half-cell with Sn(TFSI)₂ addition, 630 mAh/g, is still higher than that of the reference half cell (only 500 mAh/g).

### Example II—Sn Salt Concentration Effect

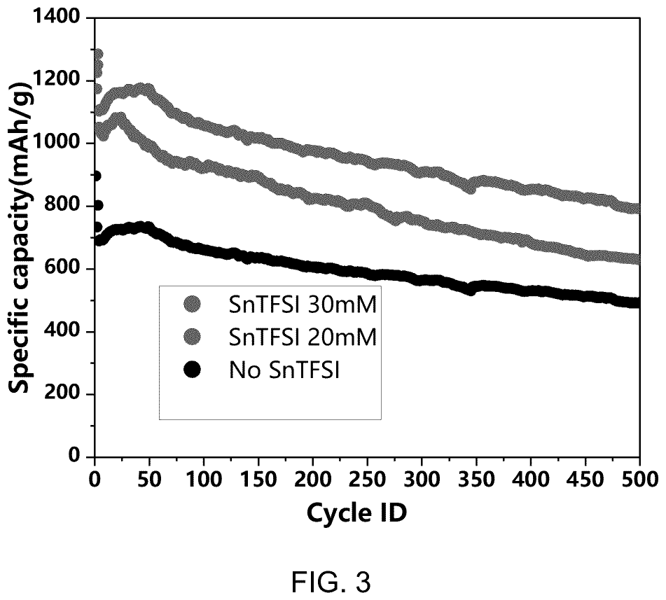

The effect of Sn(TFSI)₂ concentration on the specific capacity and cycle stability is shown in FIG. 3. When the concentration of Sn(TFSI)₂ was increased from 20 mM to 30 mM, the specific capacity of Si@void@C half cells improved further (by ˜57%) while the capacity retention remains similar. The improved specific capacity with higher Sn(TFSI)₂ content can be attributed to further enhancement in the electronic conductivity and thus even more Si@void@C particles participate in the redox reaction in the early charge/discharge processes.

It is important to point out that the specific capacity of the Si@void@C half-cell with the addition of 30 mM SnTFSI at the electrode level (i.e., including the consideration of PAA and CB weights) are 880 mAh/g-Si+PAA+CB and 640 mAh/g-Si+PAA+CB at the 1^{st} and 500^{th} service cycles, respectively. These specific capacities are superior to those of graphite anodes at the electrode level. Specifically, the typical specific capacity of graphite anodes at the electrode level is 326.6 mAh/g-Graphite+CB+PVDF (assuming the specific capacity of graphite as 355 mAh/g-graphite at the rate of 0.1 A/g-graphite and the electrode composition composed of 92 wt % graphite, 2 wt % CB and 6 wt % PVDF). As such, the specific capacities of Si@void@C anodes with Sn(TFSI)₂ at the electrode level are 169.4% and 95.9% higher than that of graphite anodes at the 1st and 500th cycles, respectively. Thus, Si@void@C anodes demonstrated in this invention can replace the state-of-the-art graphite anodes for applications that require 500 cycles with much higher energy densities.

### Example III—Effect of Sn(TFSI)₂ on Coulombic Efficiency of Si@Void@C Cells

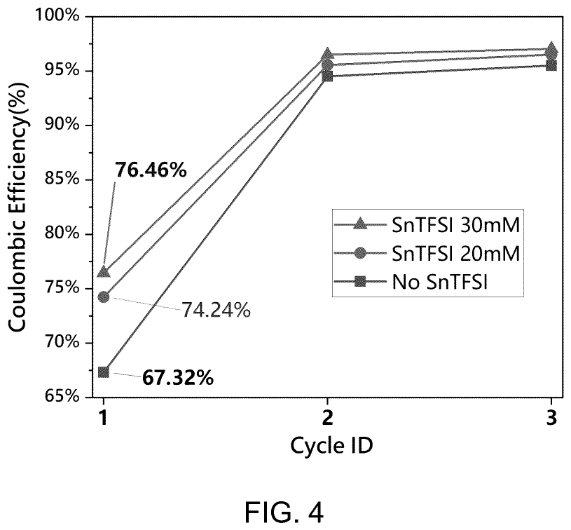

The coulombic efficiency (CE) of Si@void@C half cells was also improved with the addition of Sn(TFSI)₂, especially in the formation cycles (FIG. 4). The low CE of Si electrodes are typically due to two major reasons: (i) formation of SEI layers, which consumes Li ions, and (ii) cracking of Si particles, which leads to more SEI layer formation as well as loss of some fractured Si particles in contact with the conductive CB network. With the addition of Sn(TFSI)₂ most Si@void@C particles are coated with Sn metal and remain electronically conductive and can still participate in the redox reactions even after fracturing. As a result of this improvement, the CE is increased.

Thus, the invention provides an improved silicon-based anode for lithium batteries. The invention provides a method for relatively easy in-situ surface coating of anode particles with a metal, which enhances both the electronic conductivity and specific capacity of the anode.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of improving silicon based anodes, the method comprising:
providing a silicon anode; and
electrochemically depositing a layer of a metal on surfaces of the anode.

2. The method of claim 1, wherein the silicon based anode comprises a plurality of silicon and/or silicon oxide particles coated with the layer of metal.

3. The method of claim 2, wherein the silicon based anode comprises carbon particles, carbon nanotubes, carbon coatings, and/or graphene.

4. The method of claim 1, wherein the metal comprises tin (Sn), indium (In), magnesium (Mg), aluminum (Al), calcium (Ca), or combinations thereof.

5. The method of claim 1, further comprising adding a metallic salt to an electrolyte in combination with the silicon anode.

6. The method of claim 5, further comprising:
providing an electrochemical cell including the electrolyte, the silicon anode, and an opposing cathode; and
applying an electric current to the anode to attract ions of the metal to coat silicon particles in the anode.

7. The method of claim 1, further comprising:
adding ions of the metal to an electrolyte in combination with the silicon anode.

8. The method of claim 6, where the adding ions of the metal comprises adding a metallic salt to the electrolyte.

9. The method of claim 8, wherein the metallic salt comprises a metal-trifluoromethanesulfonylimide, metal tetrafluoroborate, metal hexafluorophosphate, metal bis(oxalato)borate, metal difluoro(oxalato)borate, or combinations thereof.

10. The method of claim 8, further comprising adding tin bis(trifluoromethanesulfonyl)imide (Sn(TFSI)₂), tin tetrafluoroborate (Sn(BF₄)₂), tin hexafluorophosphate (Sn(PF₆)₂), tin bis(oxalato)borate (Sn(B(C₂O₄)₂)₂), tin difluoro(oxalato)borate (Sn(BF₂C₂O₄)₂), indium bis(trifluoromethanesulfonyl)imide (In(TFSI)₃), indium tetrafluoroborate (In(BF₄)₃), indium hexafluorophosphate (In(PF₆)₃), indium bis(oxalato)borate (In(B(C₂O₄)₂)₃), indium difluoro(oxalato)borate (In(BF₂C₂O₄)₃), magnesium bis(trifluoromethanesulfonyl)imide (Mg(TFSI)₂), magnesium tetrafluoroborate (Mg(BF₄)₂), magnesium hexafluorophosphate (Mg(PF₆)₂), magnesium bis(oxalato)borate (Mg(B(C₂O₄)₂)₂), magnesium difluoro(oxalato)borate (Mg(BF₂C₂O₄)₂), aluminum bis(trifluoromethanesulfonyl)imide (Al(TFSI)₃), aluminum tetrafluoroborate (Al(BF₄)₃), aluminum hexafluorophosphate (Al(PF₆)₃), aluminum bis(oxalato)borate (Al(B(C₂O₄)₂)₃), aluminum difluoro(oxalato)borate (Al(BF₂C₂O₄)₃), calcium bis(trifluoromethanesulfonyl)imide, (Ca(TFSI)₂), calcium tetrafluoroborate (Ca(BF₄)₂), calcium hexafluorophosphate (Ca(PF₆)₂), calcium bis(oxalato)borate (Ca(B(C₂O₄)₂)₂), calcium difluoro(oxalato)borate (Ca(BF₂C₂O₄)₂), or combinations thereof to the electrolyte.

11. The method of claim 1, further comprising fabricating the silicon anode by binding a plurality of silicon particles together and/or to a current collector.

12. A method of improving silicon based anodes, the method comprising:
placing a silicone anode in an electrochemical cell having an opposing cathode, an electrolyte, and a power source connected to the silicon anode and the cathode;
adding a metallic salt to the electrolyte to form metal ions; and
delivering an electric current to the anode to electrochemically deposit a layer of the metal ions on the surface of the silicon particles in the anode, wherein the metal ions are reduced to a metal layer on the surface of the silicon particles in the anode.

13. The method of claim 12, wherein the silicon based anode comprises a plurality of silicon and/or silicon oxide particles.

14. The method of claim 12, wherein the metal ions comprise tin (Sn), indium (In), magnesium (Mg), aluminum (Al), calcium (Ca), or combinations thereof.

15. An anode, comprising an anode body including a plurality of silicon or silicon oxide particles, and an electrochemically deposited layer of a metal on surfaces of the silicon or silicon oxide particles in the anode.

16. The anode of claim 15, wherein the metal comprises tin (Sn), indium (In), magnesium (Mg), aluminum (Al), calcium (Ca), or combinations thereof.

17. The anode of claim 15, further comprising carbon particles, carbon nanotubes, carbon coatings, and/or graphene.

18. An electrochemical cell comprising the anode of claim 16.
